(19) United States
(12) Patent Application Publication
(10) Pub. No.: US 2012/0117051 A1
(43) Pub. Date: May 10, 2012

(54) MULTI-MODAL APPROACH TO SEARCH QUERY INPUT

(75) Inventors: JIYANG LIU, Yarrow Point, WA (US); JIAN SUN, Beijing (CN); HEUNG-YEUNG SHUM, Hong Kong (CN); XIAOSONG YANG, Beijing (CN); YU-TING KUO, Sammamish, WA (US); LEI ZHANG, Beijing (CN); YI LI, Issaquah, WA (US); QIFA KE, Cupertino, CA (US); CE LIU, Arlington, MA (US)

(73) Assignee: MICROSOFT CORPORATION, Redmond, WA (US)

(21) Appl. No.: 12/940,538

(22) Filed: Nov. 5, 2010

(51) Int. Cl. G06F 17/30

(52) U.S. Cl. 707/707; 707/E17.108

(57) ABSTRACT

Search queries containing multiple modes of query input are used to identify responsive results. The search queries can be composed of combinations of keyword or text input, image input, video input, audio input, or other modes of input. The multiple modes of query input can be present in an initial search request, or an initial request containing a single type of query input can be supplemented with a second type of input. In addition to providing responsive results, in some embodiments additional query refinements or suggestions can be made based on the content of the query or the initially responsive results.

### BACKGROUND

Various methods for search and retrieval of information, such as by a search engine over a wide area network, are known in the art. Such methods typically employ text-based searching. Text-based searching employs a search query that comprises one or more textual elements such as words or phrases. The textual elements are compared to an index or other data structure to identify documents such as web pages that include matching or semantically similar textual content, metadata, file names, or other textual representations.

The known methods of text-based searching work relatively well for text-based documents, however they are difficult to apply to image files and data. In order to search image files via a text-based query the image file must be associated with one or more textual elements, such as a title, file name, or other metadata or tags. The search engines and algorithms employed for text based searching cannot search image files based on the content of the image and thus, are limited to identifying search result images based only on the data associated with the images.

Methods for content-based searching of images have been developed that analyze the content of an image to identify visually similar images. However, such methods can be limited with respect to identifying text-based documents that are relevant to the input of the image search.

### SUMMARY

In various embodiments, methods are provided for using multiple modes of input as part of a search query. The methods allow for search queries composed of combinations of keyword or text input, image input, video input, audio input, or other modes of input. A search for responsive documents can then be performed based on features extracted from the various modes of query input. The multiple modes of query input can be present in an initial search request, or an initial request containing a single type of query input can be supplemented with a second type of input. In addition to providing responsive results, in some embodiments additional query refinements or suggestions can be made based on the content of the query or the initially responsive results.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

The invention is described in detail below with reference to the attached drawing figures, wherein:

FIG. 1 is a block diagram of an exemplary computing environment suitable for use in implementing embodiments of the present invention.

FIG. 2 schematically shows a network environment suitable for performing embodiments of the invention.

FIG. 3 schematically shows an example of the components of a user interface according to an embodiment of the invention.

FIG. 4 shows the relationship between various components and processes involved in performing an embodiment of the invention.

FIGS. 5-9 show an example of extraction of image features from an image according to an embodiment of the invention.

FIGS. 10-12 show examples of methods according to various embodiments of the invention.

### DETAILED DESCRIPTION

### Overview

In various embodiments, systems and methods are provided for integrating keyword or text-based search input with other modes of search input. Examples of other modes of search input can include image input, video input, and audio input. More generally, the systems and methods can allow for performance of searches based on multiple modes of input in the query. The resulting embodiments of multi-modal search systems and methods can provide a user greater flexibility in providing input to a search engine. Additionally, when a user initiates a search with one type of input, such as image input, a second type of input (or multiple other types of input) can then be used to refine or otherwise modify the responsive search results. For example, a user can enter one or more keywords to associate with an image input. In many situations, the association of additional keywords with an image input can provide a clearer indication of user intent than either an image input or keyword input alone.

In some embodiments, searching for responsive results based on a multi-modal search input is performed by using an index that includes terms related to more than one type of data, such as an index that includes text-based keywords, image-based “keywords”, video-based “keywords”, and audio-based “keywords”. One option for incorporating “keywords” for input modes other than text based searching can be to correlate the multi-modal features with artificial keywords. These artificial keywords can be referred to as descriptor keywords. For example, image features used for image-based searching can be correlated with descriptor keywords, so that the image-based searching features appear in the same inverted index as traditional text-based keywords. For example, an image of the “Space Needle” building in Seattle may contain a plurality of image features. These image features can be extracted from the image, and then correlated with descriptor “keywords” for incorporation into an inverted index with other text-based keyword terms.

In addition to incorporating descriptor keywords into a text-based keyword index, descriptor keywords from an image (or another type of non-text input) can also be associated with the traditional keyword terms. In the example above, the term “space needle” can be correlated with one or more descriptor keywords from an image of the Space Needle. This can allow for suggested or revised queries that include the descriptor keywords, and therefore are better suited to perform an image based search for other images similar to the Space Needle image. Such suggested queries can be provided to the user to allow for improved searching for other images related to the Space Needle image, or the suggested queries can be used automatically to identify such related images.

In the discussion below, the following definitions are used to describe aspects of performing a multi-modal search. A feature refers to any type of information that can be used as part of selection and/or ranking of a document as being responsive to a search query. Features from a text-based query typically include keywords. Features from an image-based query can include portions of an image identified as being distinctive, such as portions of an image that have contrasting intensity or portions of an image that correspond to a person's face for facial recognition. Features from an audio-based query can include variations in the volume level of the audio or other detectable audio patterns. A keyword refers to a conventional text-based search term. A keyword can refer to one or more words that are used as a single term for identifying a document responsive to a query. A descriptor keyword refers to a keyword that has been associated with a non-text based feature. Thus, a descriptor keyword can be used to identify an image-based feature, a video-based feature, an audio-based feature, or other non-text features. A responsive result refers to any document that is identified as relevant to a search query based on selection and/or ranking performed by a search engine. When a responsive result is displayed, the responsive result can be displayed by displaying the document itself, or an identifier of the document can be displayed. For example, the conventional hyperlinks, also known as the “blue links” returned by a text-based search engine represent identifiers for, or links to, other documents. By clicking on a link, the represented document can be accessed. Identifiers for a document may or may not provide further information about the corresponding document.

### Receiving a Multi-Modal Search Query

Features from multiple search modes can be extracted from a query and used to identify results that are responsive to the query. In an embodiment, multiple modes of query input can be provided by any convenient method. For example, a user interface for receiving query input can include a dialog box for receiving keyword query input. The user interface can also include a location for receiving an image selected by the user, such as an image query box that allows a user to “drop” a desired input image into the user interface. Alternatively, the image query box can receive a file location or network address as the source of the image input. A similar box or location can be provided for identifying an audio file, video file, or another type of non-text input for use as a query input.

The multiple modes of query input do not need to be received at the same time. Instead, one type of query input can be provided first, and then a second mode of input can be provided to refine the query. For example, an image of movie star can be submitted as a query input. This will return a series of matching results that likely include images. The word “actor” can then be typed into a search query box as a keyword, in order to refine the search results based on the user's desire to know the name of the movie star.

After receiving multi-modal search information, the multi-modal information can be used as a search query to identify responsive results. The responsive results can be any type of document determined to be relevant by a search engine, regardless of the input mode of the search query. Thus, image items can be identified as responsive documents to a text-based query, or text-based items can be responsive documents to an audio-based query. Additionally, a query including more than one mode of input can also be used to identify responsive results of any available type. The responsive results displayed to a user can be in the form of the documents themselves, or in the form of identifiers for responsive documents.

One or more indexes can be used to facilitate identification of responsive results. In an embodiment, a single index, such as an inverted index, can be used to store keywords and descriptor keywords based on all types of search modes. Alternatively, a single ranking system can use multiple indexes to store terms or features. Regardless of the number or form of the indexes, the one or more indexes can be used as part of an integrated selection and/or ranking method for identifying documents that are responsive to a query. The selection method and/or ranking method can incorporate features based on any available mode of query input.

Text-based keywords that are associated with other types of input can also be extracted for use. One option for incorporating multiple modes of information can be to use text information associated with another mode of query input. An image, video, or audio file will often have metadata associated with the file. This can include the title of the file, a subject of the file, or other text associated with the file. The other text can include text that is part of a document where the media file appears as a link, such as a web page, or other text describing the media file. The metadata associated with an image, video, or audio file can be used to supplement a query input in a variety of ways. The text metadata can be used to form additional query suggestions that are provided to a user. The text can also be used automatically to supplement an existing search query, in order to modify the ranking of responsive results.

In addition to using metadata associated with an input query, the metadata associated with a responsive result can be used to modify a search query. For example, a search query based on an image may result in a known image of the Eiffel Tower as a responsive result. The metadata from the responsive result may indicate that the Eiffel Tower is the subject of the responsive image result. This metadata can be used to suggest additional queries to a user, or to automatically supplement the search query.

There are multiple ways to extract metadata. The metadata extraction technique may be predetermined or it may be selected dynamically either by a person or an automated process. Metadata extraction techniques can include, but are not limited to: (1) parsing the filename for embedded metadata; (2) extracting metadata from the near-duplicate digital object; (3) extracting the surrounding text in a web page where the near-duplicate digital object is hosted; (4) extracting annotations and commentary associated with the near-duplicate from a web site supporting annotations and commentary where the near-duplicate digital media object is stored; and (5) extracting query keywords that were associated with the near-duplicate when a user selected the near-duplicate after a text query. In other embodiments, metadata extraction techniques may involve other operations.

Some of the metadata extraction techniques start with a body of text and sift out the most concise metadata. Accordingly, techniques such as parsing against a grammar and other token-based analysis may be utilized. For example, surrounding text for an image may include a caption or a lengthy paragraph. At least in the latter case, the lengthy paragraph may be parsed to extract terms of interest. By way of another example, annotations and commentary data are notorious for containing text abbreviations (e.g. IMHO for “in my humble opinion”) and emotive particles (e.g. smileys and repeated exclamation points). IMHO, despite its seeming emphasis in annotations and commentary, is likely to be a candidate for filtering out where searching for metadata.

In the event multiple metadata extraction techniques are chosen, a reconciliation method can provide a way to reconcile potentially conflicting candidate metadata results. Reconciliation may be performed, for example, using statistical analysis and machine learning or alternatively via rules engines.

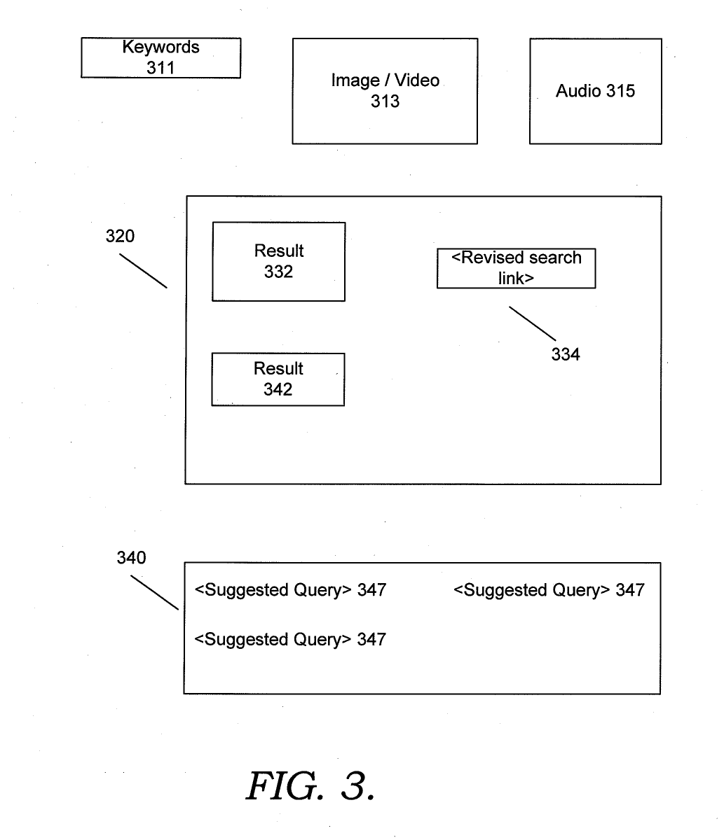

FIG. 3 provides an example of a user interface suitable for receiving multi-modal search input and displaying responsive results according to an embodiment of the invention. In FIG. 3, the user interface provides input locations for three types of query input. Input box 311 can receive keyword input, such as the text-based input typically used by a conventional search engine. Input box 313 can receive an image and/or video file as input. An image or video file that is pasted or otherwise “dropped” into input box 313 can be analyzed using image analysis techniques to identify features that can be extracted for searching. Similarly, input box 315 can receive an audio file as input.

Area 320 contains a listing of responsive results. In the embodiment shown in FIG. 3, responsive results 332 and 342 are currently shown. Responsive result 332 is an identifier, such as a thumbnail, for an image document identified as responsive to a search. In addition to image result 332, a link or icon 334 is also provided to allow for a revised search that incorporates the image result 332 (or the descriptor keywords associated with image result 332) as part of the revised query. Responsive result 344 corresponds to an identifier for a text-based document.

Area 340 contains a listing of suggested queries 347 based on the initial query. The suggested queries 347 can be generated using conventional query suggestion algorithms. Suggested queries 347 can also be based on metadata associated with input submitted in image/video input 312 or audio input 314. Still other suggested queries 347 can be based on metadata associated with a responsive result, such as responsive result 332.

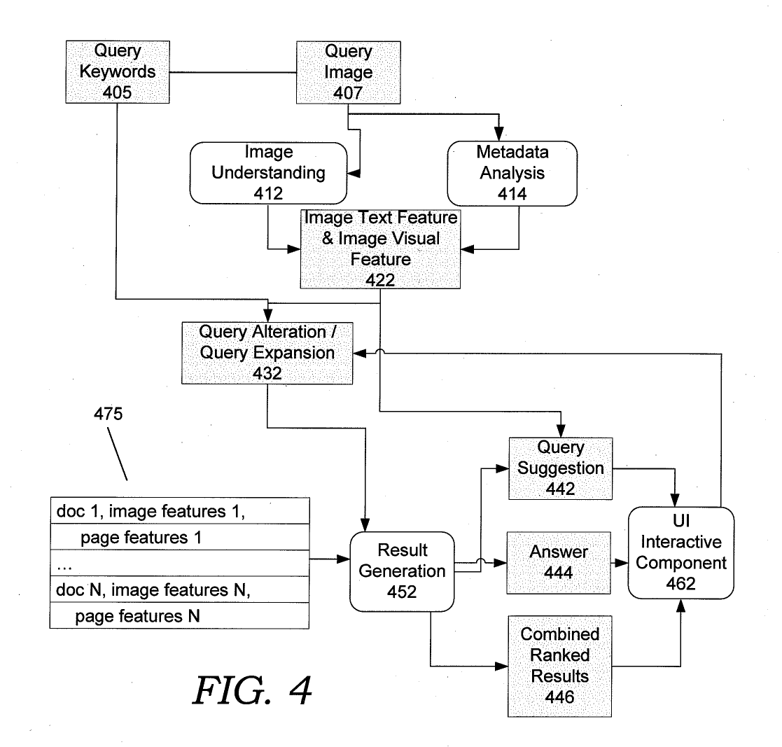

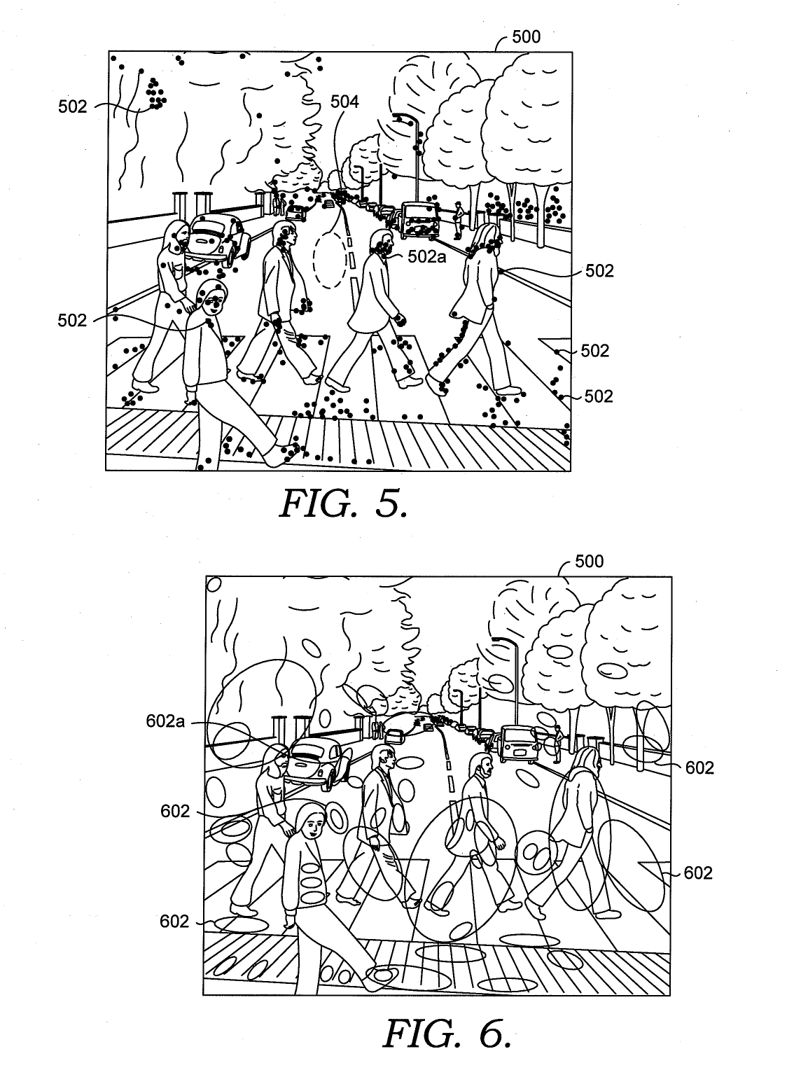

FIG. 4 schematically shows the interaction of various systems and/or processes for performing a multi-modal search according to an embodiment of the invention. In the embodiment shown in FIG. 4, the multi-modal search corresponds to a search based on both keyword query input and image query input. In FIG. 4, a search is started based on receiving a query. The query includes query keywords 405 and query image 407. To process query image 407, an image understanding component 412 can be used to identify features within the image. The features extracted from the query image 407 by image understanding component 412 can be assigned descriptor keywords by image text feature and image visual feature component 422. An example of methods that can be used by an image understanding component 412 is described below in conjunction with FIGS. 5-9. Image understanding component 412 can also include other types of image understanding methods, such as facial recognition methods, or methods for analyzing color similarity in an image. Metadata analysis component 414 can identify metadata associated with the query image 407. This can include information embedded within the image file and/or stored with the file by the operating system, such as a title for the image or annotations stored within the file. This can also include other text associated with the image, such as text in a URL pathway that is entered to identify the image for use in the search, or text located near the image for an image located on or embedded in a web page or other text-based document. Image text feature and image visual feature component 422 can identify keyword features based on the output from metadata analysis 414.

After identifying query terms 405 and any additional features in image text feature and image visual feature component 422, the resulting query can optionally be altered or expanded in component 432. The query alteration or expansion can be based on features derived from metadata in metadata analysis component 414 and image text feature/image visual feature component 422. Another source for query alteration or expansion can be feedback from the UI Interactive Component 462. This can include additional query information provided by a user, as well as query suggestions 442 based on the responsive results from the current or prior queries. The optionally expanded or altered query can then be used to generate responsive results 452. In FIG. 4, result generation 452 involves using the query to identify responsive documents in a database 475, which includes both text and image features for the documents in the database. Database 475 can represent an inverted index or any other convenient type of storage format for identifying responsive results based on a query.

Depending on the embodiment, result generation 452 can provide one or more types of results. In some situations, an identification of a most likely match can be desirable, such as one or a few highly ranked responsive results. This can be provided as an answer 444. Alternatively, a listing of responsive results in a ranked order may be desirable. This can be provided as combined ranked results 446. In addition to an answer or ranked results, one or more query suggestions 442 can also be provided to a user. The interaction with a user, including display of results and receipt of queries, can be handled by a UI interactive component 462.

### Multimedia-Based Searching Methods

FIGS. 5-9 schematically show the processing of an exemplary image 500 in accordance with an embodiment of the invention. In FIG. 5, an image 500 is processed using an operator algorithm to identify a plurality of interest points 502. The operator algorithm includes any available algorithm that is useable to identify interest points 502 in the image 500. In an embodiment, the operator algorithm can be a difference of Gaussians algorithm or a Laplacian algorithm as are known in the art. In an embodiment, the operator algorithm is configured to analyze the image 500 in two dimensions. Optionally, when the image 500 is a color image, the image 500 can be converted to grayscale.

An interest point 502 can include any point in the image 500 as depicted in FIG. 5, as well as a region 602, area, group of pixels, or feature in the image 500 as depicted in FIG. 6. The interest points 502 and regions 602 are referred to hereinafter as interest points 502 for sake of clarity and brevity, however reference to the interest points 502 is intended to be inclusive of both interest points 502 and the regions 602. In an embodiment, an interest point 502 is located on an area in the image 500 that is stable and includes a distinct or identifiable feature in the image 500. For example, an interest point 502 is located on an area of an image having sharp features with high contrast between the features such as depicted at 502a and 602a. Conversely, an interest point is not located in an area with no distinct features or contrast, such as a region of constant color or grayscale as indicated by 504.

The operator algorithm identifies any number of interest points 502 in the image 500, such as, for example, thousands of interest points. The interest points 502 may be a combination of points 502 and regions 602 in the image 500 and the number thereof may be based on the size of the image 500. The image processing component 302 computes a metric for each of the interest points 502 and ranks the interest points 502 according to the metric. The metric might include a measure of the signal strength or the signal to noise ratio of the image 500 at the interest point 502. The image processing component 302 selects a subset of the interest points 502 for further processing based on the ranking. In an embodiment, the one hundred most salient interest points 502 having the highest signal to noise ratio are selected, however any desired number of interest points 502 may be selected. In another embodiment, a subset is not selected and all of the interest points are included in further processing.

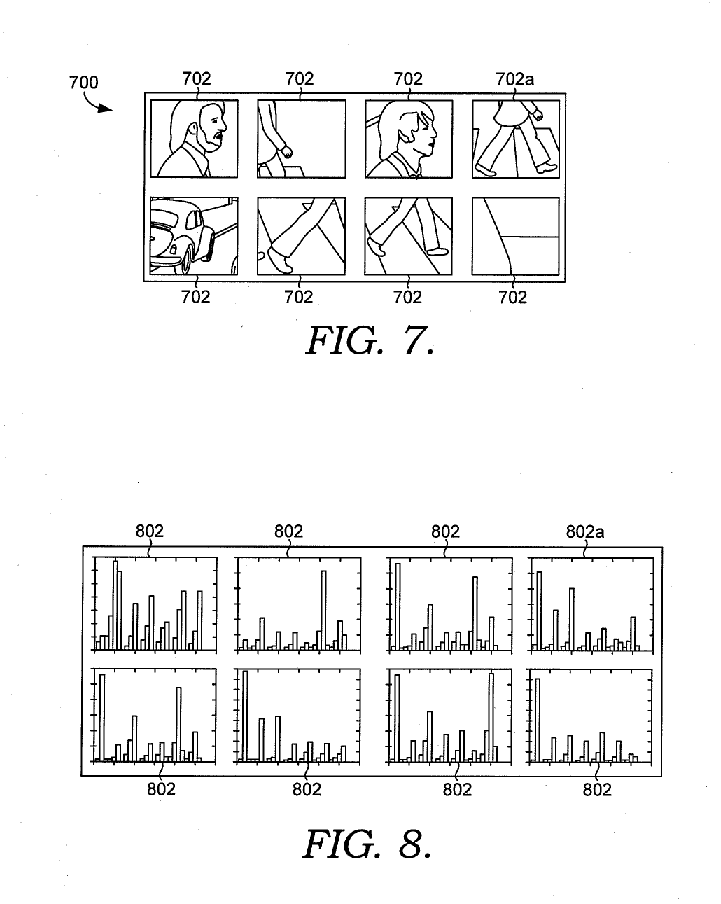

As depicted in FIG. 7, a set of patches 700 can be identified that correspond to the selected interest points 502. Each patch 702 corresponds to a single selected interest point 502. The patches 702 include an area of the image 500 that includes the respective interest point 502. The size of each patch 702 to be taken from the image 500 is determined based on an output from the operator algorithm for each of the selected interest points 502. Each of the patches 702 may be of a different size and the areas of the image 500 to be included in the patches 702 may overlap. Additionally, the shape of the patches 702 is any desired shape including a square, rectangle, triangle, circle, oval, or the like. In the illustrated embodiment, the patches 702 are square in shape.

The patches 702 can be normalized as depicted in FIG. 7. In an embodiment, the patches 702 are normalized to conform each of the patches 702 to an equal size, such as an X pixel by X pixel square patch. Normalizing the patches 702 to an equal size may include increasing or decreasing the size and/or resolution of a patch 702, among other operations. The patches 702 may also be normalized via one or more other operations such as applying contrast enhancement, despeckling, sharpening, and applying a grayscale, among others.

A descriptor can also be determined for each normalized patch. A descriptor can be a description of a patch that can be incorporated as a feature for use in an image search. A descriptor can be determined by calculating statistics of the pixels in a patch 702. In an embodiment, a descriptor is determined based on the statistics of the grayscale gradients of the pixels in a patch 702. The descriptor might be visually represented as a histogram for each patch, such as a descriptor 802 depicted in FIG. 8 (wherein the patches 702 of FIG. 7 correspond with similarly located descriptors 802 in FIG. 8). The descriptor might also be described as a multi-dimensional vector such as, for example and not limitation, a multi-dimensional vector that is representative of pixel grayscale statistics for the pixels in a patch. A T2S2 36-dimensional vector is an example of a vector that is representative of pixel grayscale statistics.

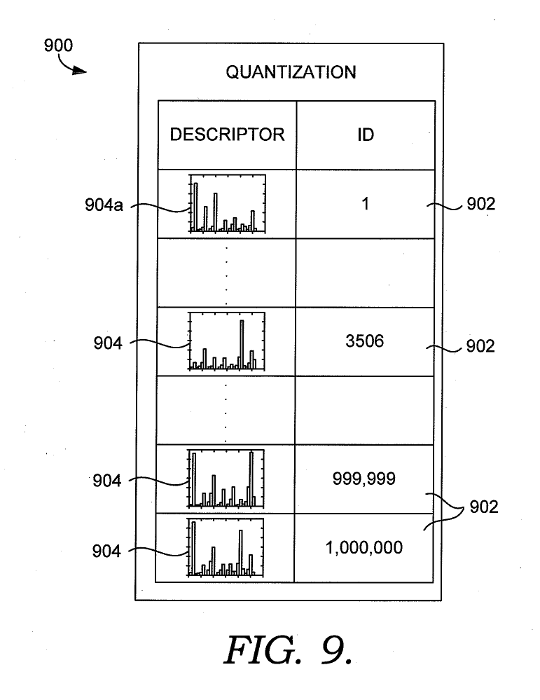

As depicted in FIG. 9, a quantization table 900 can be employed to correlate a descriptor keyword 902 with each descriptor 802. The quantization table 900 can include any table, index, chart, or other data structure useable to map the descriptors 802 to the descriptor keyword 902. Various forms of quantization tables 900 are known in the art and are useable in embodiments of the invention. In an embodiment, the quantization table 900 is generated by first processing a large quantity of images (e.g. image 500), for example a million images, to identify descriptors 802 for each image. The descriptors 802 identified therefrom are then statistically analyzed to identify clusters or groups of descriptors 802 having similar, or statistically similar, values. For example, the values of variables in T2S2 vectors are similar. A representative descriptor 904 of each cluster is selected and assigned a location in the quantization table 900 as well as a corresponding descriptor keyword 902. The descriptor keywords 902 can include any desired indicator that identifies a corresponding representative descriptor 904 For example, the descriptor keywords 902 can include integer values as depicted in FIG. 9, or alpha-numeric values, numeric values, symbols, text, or a combination thereof. In some embodiments, descriptor keywords 902 can include a sequence of characters that identify the descriptor keyword as being associated with non-text-based search mode. For example, all descriptor keywords can include a series of three integers followed by an underscore character as the first four characters in the keyword. This initial sequence could then be used to identify the descriptor keyword as being associated with an image.

For each descriptor 802, a most closely matching representative descriptor 904 can be identified in the quantization table 900. For example, a descriptor 802a depicted in FIG. 8 most closely corresponds with a representative descriptor 904a of the quantization table 900 in FIG. 9. The descriptor keywords 902 for each of the descriptors 802 are thereby associated with the image 500 (e.g. the descriptor 802a corresponds with the descriptor identifier 902 “1”). The descriptor keywords 902 associated with the image 500 may each be different from one another or one or more of the descriptor keywords 902 may be associated with the image 500 multiple times (e.g. the image 500 might have descriptor keywords 902 of “1, 2, 3, 4” or “1, 2, 2, 3”). In an embodiment, to take into account characteristics, such as image variations, a descriptor 802 may be mapped to more than one descriptor identifier 902 by identifying more than one representative descriptor 904 that most nearly matches the descriptor 802 and the respective descriptor keyword 902 therefor. Based on the above, the content of an image 500 having a set of identified interest points 502 can be represented by a set of descriptor keywords 902.

In another embodiment, other types of image-based searching can be integrated into a search scheme. For example, facial recognition methods can provide another type of image search. In addition to and/or in place of identifying descriptor keywords as described above, facial recognition methods can be used to determine the identities of people in an image. The identity of a person in an image can be used to supplement a search query. Another option can be to have a library of people for matching with facial recognition technology. Metadata can be included in the library for various people, and this stored metadata can be used to supplement a search query.

The above provides a description for adapting image-based search schemes to a text-based search scheme. A similar adaptation can be made for other modes of search, such as an audio-based search scheme. In an embodiment, any convenient type of audio-based searching can be used. The method for audio-based searching can have one or more types of features that are used to identify audio files that have similar characteristics. As described above, the audio features can be correlated with descriptor keywords. The descriptor keywords can have a format that indicates the keyword is related to an audio search, such as having the last four characters of the keyword correspond to a hyphen followed by four numbers.

### EXAMPLES OF SEARCHING BASED ON MULTI-MODAL QUERIES

### Search Example 1

Adding image information to a text based query. One difficulty with conventional search methods is identifying desired results for common query terms. One type of search that can involve common query terms is a search for a person with a common name, such as “Steve Smith”. If a keyword query of “steve smith” is submitted to a search engine, a large number of results will likely be identified as responsive, and these results will likely correspond to a large number of different people sharing the same or a similar name.

In an embodiment, a search for a named entity can be improved by submitting a picture of the entity as part of a search query. For example, in addition to entering “steve smith” in a keyword text box, an image or video of the particular Mr. Smith of interest can be dropped into a location for receiving image based query information. Facial recognition software can then be used to match the correct “Steve Smith” with the search query. Additionally, if the image or video contains other people, results based on the additional people can be assigned a lower ranking due to the keyword query indicating the person of interest. As a result, the combination of keywords and image or video can be used to efficiently identify results corresponding to a person (or other entity) with a common name.

As a variation on the above, consider a situation where a user has an image or video of a person, but does not know the name of the person. The person could be a politician, an actor or actress, a sports figure, or any other person or other entity that can be recognized by facial recognition or image matching technology. In this situation, the image or video containing the entity can be submitted with one or more keywords as a multi-modal search query. In this situation, the one or more keywords can represent the information the user possesses regarding the entity, such as “politician” or “actress”. The additional keywords can assist the image search in various ways. One benefit of having both an image or video and keywords is that results of interest to the user can be given a higher ranking. Submitting the keyword “actress” with an image indicates a user intent to know the name of the person in the image, and would lead to the name of the actress as a higher ranked result than a result for a movie listing the actress in the credits. Additionally, for facial recognition or other image analysis technology where an exact match is not achieved, the keywords can help in ranking potentially responsive search results. If the facial recognition method identifies both a state senator and an author as potential matches, the keyword “politician” can be used to provide information about the state senator as the highest ranked results.

### Search Example 2

Query refinement for multi-modal queries. In this example, a user desires to obtain more information about a product found in a store, such as a music CD or a movie DVD. As a precursor to the search process, the user can take a picture of the cover of a music CD that is of interest. This picture can then be submitted as a search query. Using image recognition and/or matching, the CD cover can be matched to a stored image of the CD cover that includes additional metadata. This metadata can optionally include the name of the artist, the title of the CD, the names of the individual songs on the CD, or any other data regarding the CD.

A stored image of the CD cover can be returned as a responsive result, and possibly as the highest ranked result. Depending on the embodiment, the user may be offered potential query modifications on the initial results page, or the user may click on a link in order to access the potential query modifications. The query modifications can include suggestions based on the metadata, such as the name of the artist, title of the CD, or the name of one of the popular songs on the CD. These query modifications can be offered as links to the user. Alternatively, the user can be provided with an option to add some or all of the query metadata to a keyword search box. The user can also supplement the suggested modifications with additional search terms. For example, the user could select the name of the artist and then add the word “concert” to the query box. The additional word “concert” can be associated with the image for use as part of the search query. This could, for example, produce responsive results indicating future concert dates for the artist. Other options for query suggestions or modifications could include price information, news related to the artist, lyrics for a song on the CD, or other types of suggestions. Optionally, some query modifications can be automatically submitted for search to generate responsive results for the modified query without further action from the user. For example, adding the keyword “price” to the query based on the CD cover could be an automatic query modification, so that pricing at various on-line retailers is returned with the initial search results page.

Note that in the above example, a query image was submitted first, and then keywords were associated with the query as a refinement. Similar refinements can be performed by starting with a text keyword search, and then refining based on an image, video, or audio file.

### Search Example 3

Improved mobile searching. In this example, a user may know generally what to ask for, but may be uncertain how to phrase a search query. This type of mobile searching could be used for searching on any type of location, person, object, or other entity. The addition of one or more keywords allows the user to receive responsive results based on a user intent, rather than based on the best image match. The keywords can be added, for example, in a search text box prior to submitting the image as a search query. The keywords can optionally supplement any keywords that can be derived from metadata associated with a image, video, or audio file. For example, a user could take a picture of a restaurant and submit the picture as a search query along with the keyword “menu”. This would increase the ranking of results involving the menu for that restaurant. Alternatively, a user could take a video of a type of cat and submit the search query with the word “species”. This would increase the relevance of results identifying the type of cat, as opposed to returning image or video results of other animals performing similar activities. Still another option could be to submit an image of the poster for a movie along with the keyword “soundtrack”, in order to identify the songs played in the movie.

As still another example, a user traveling in a city may want information regarding the schedule for the local mass transit system. Unfortunately, the user does not know the name of the system. The user starts by typing in a keyword query of <city name> and “mass transit”. This returns a large number of results, and the user is not confident regarding which result will be most helpful. The user then notices a logo for the transit system at a nearby bus stop. The user takes a picture of the logo, and refines the search using the logo as part of the query. The bus system associated with the logo is then returned as the highest ranked result, providing the user with confidence that the correct transit schedule has been identified

### Search Example 4

Multi-modal searching involving audio files. In addition to video or images, other types of input modes can be used for searching. Audio files represent another example of a suitable query input. As described above for images or videos, an audio file can be submitted as a search query in conjunction with keywords. Alternatively, the audio file can be submitted either prior to or after the submission of another type of query input, as part of query refinement. Note that in some embodiments, a multi-modal search query may include multiple types of query input without a user providing any keyword input. Thus, a user could provide an image and a video or a video and an audio file. Still another option could be to include multiple images, videos, and/or audio files along with keywords as query inputs.

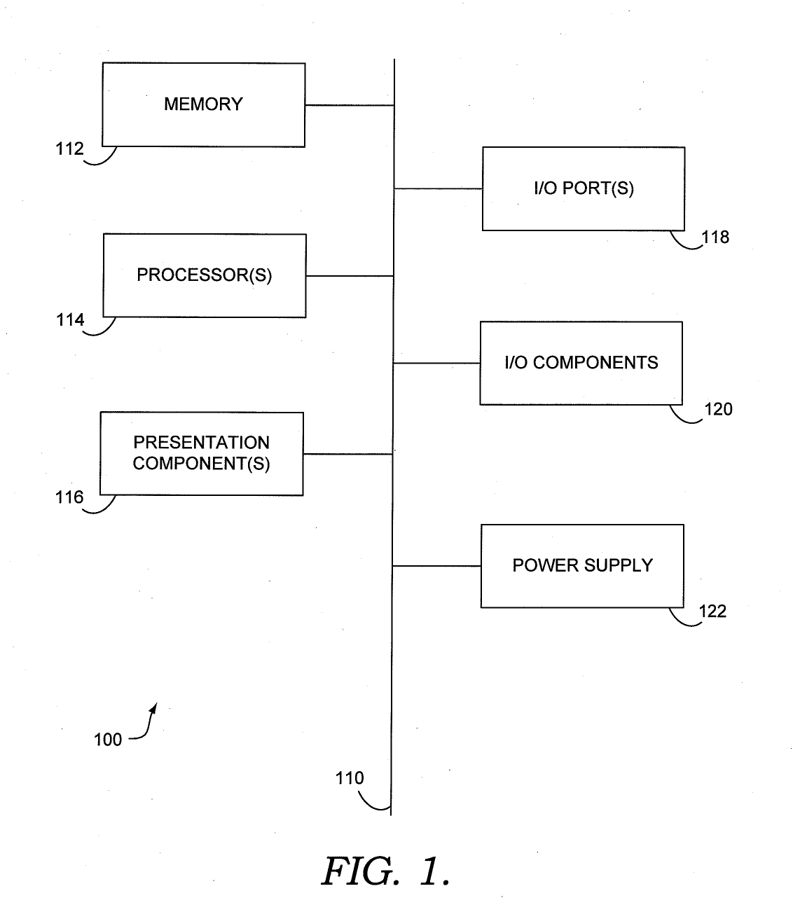

Having briefly described an overview of various embodiments of the invention, an exemplary operating environment suitable for performing the invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, and the like. The invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, carrier wave, or any other medium that can be used to encode desired information and which can be accessed by the computing device 100. In an embodiment, the computer storage media can be selected from tangible computer storage media. In another embodiment, the computer storage media can be selected from non-transitory computer storage media.

The memory 112 includes computer-storage media in the form of volatile and/or nonvolatile memory. The memory may be removable, non-removable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

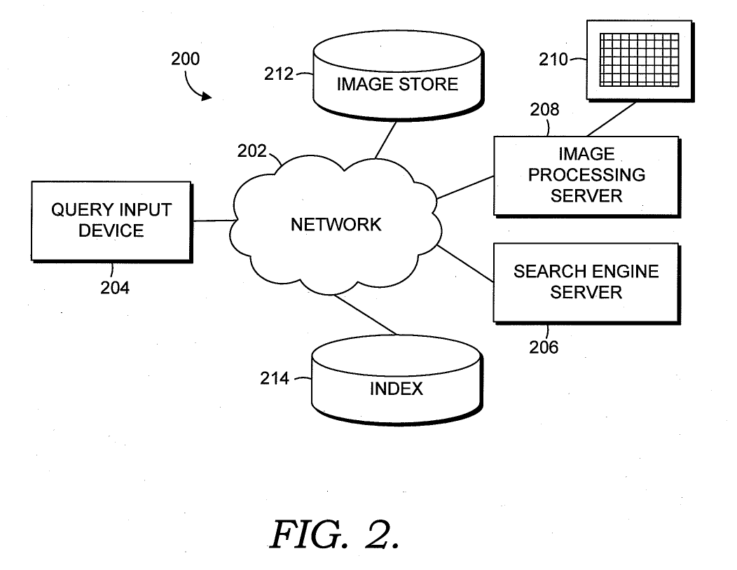

With additional reference to FIG. 2, a block diagram depicting an exemplary network environment 200 suitable for use in embodiments of the invention is described. The environment 200 is but one example of an environment that can be used in embodiments of the invention and may include any number of components in a wide variety of configurations. The description of the environment 200 provided herein is for illustrative purposes and is not intended to limit configurations of environments in which embodiments of the invention can be implemented.

The environment 200 includes a network 202, a query input device 204, and a search engine server 206. The network 202 includes any computer network such as, for example and not limitation, the Internet, an intranet, private and public local networks, and wireless data or telephone networks. The query input device 204 is any computing device, such as the computing device 100, from which a search query can be provided. For example, the query input device 204 might be a personal computer, a laptop, a server computer, a wireless phone or device, a personal digital assistant (PDA), or a digital camera, among others. In an embodiment, a plurality of query input devices 204, such as thousands or millions of query input devices 204, are connected to the network 202.

The search engine server 206 includes any computing device, such as the computing device 100, and provides at least a portion of the functionalities for providing a content-based search engine. In an embodiment a group of search engine servers 206 share or distribute the functionalities required to provide search engine operations to a user population.

An image processing server 208 is also provided in the environment 200. The image processing server 208 includes any computing device, such as computing device 100, and is configured to analyze, represent, and index the content of an image as described more fully below. The image processing server 208 includes a quantization table 210 that is stored in a memory of the image processing server 208 or is remotely accessible by the image processing server 208. The quantization table 210 is used by the image processing server 208 to inform a mapping of the content of images to allow searching and indexing of image features.

The search engine server 206 and the image processing server 208 are communicatively coupled to an image store 212 and an index 214. The image store 212 and the index 214 include any available computer storage device, or a plurality thereof, such as a hard disk drive, flash memory, optical memory devices, and the like. The image store 212 provides data storage for image files that may be provided in response to a content-based search of an embodiment of the invention. The index 214 provides a search index for content-based searching of documents available via network 202, including the images stored in the image store 212. The index 214 may utilize any indexing data structure or format, and preferably employs an inverted index format. Note that in some embodiments, image store 212 can be optional.

An inverted index provides a mapping depicting the locations of content in a data structure. For example, when searching a document for a particular keyword (including a keyword descriptor), the keyword is found in the inverted index which identifies the location of the word in the document and/or the presence of a feature in an image document, rather than searching the document to find locations of the word or feature.

In an embodiment, one or more of the search engine server 206, image processing server 208, image store 212, and index 214 are integrated in a single computing device or are directly communicatively coupled so as to allow direct communication between the devices without traversing the network 202.

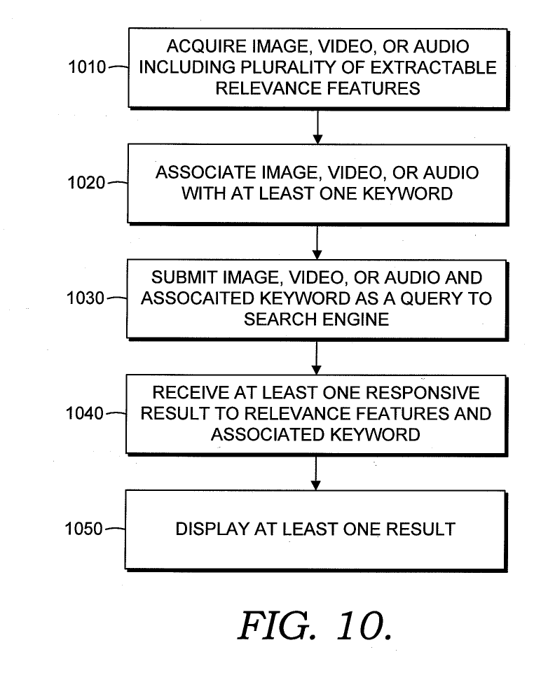

FIG. 10 depicts a method according to an embodiment of the invention, or alternatively executable instructions for a method embodied on computer storage media according to an embodiment of the invention. In FIG. 10, an image, a video, or an audio file is acquired 1010 that includes a plurality of relevance features that can be extracted. The image, video, or audio file is associated 1020 with at least one keyword. The image, video, or audio file and associated keyword are submitted 1030 as a query to a search engine. At least one responsive result is received 1040 that is responsive to both the plurality of relevance features and the associated keyword. The at least one responsive result is then displayed 1050.

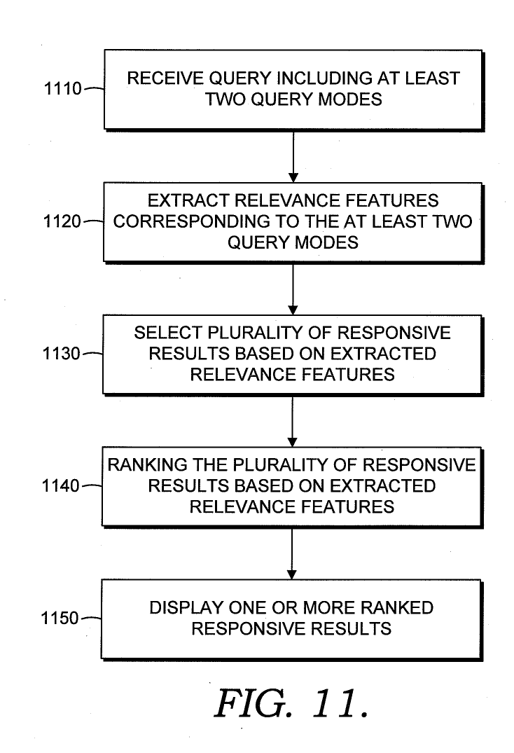

FIG. 11 depicts another method according to an embodiment of the invention, or alternatively executable instructions for a method embodied on computer storage media according to an embodiment of the invention. In FIG. 11, a query is received 1110 that includes at least two query modes. Relevance features are extracted 1120 corresponding to the at least two query modes from the query. A plurality of responsive results are selected 1130 based on the extracted relevance features. The plurality of responsive results are also ranked 1140 based on the extracted relevance features. One or more of the ranked responsive results are then display 1150.

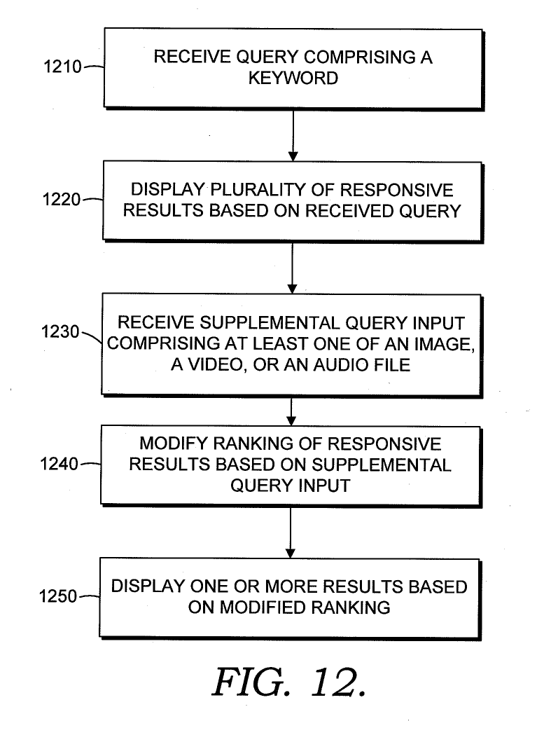

FIG. 12 depicts another method according to an embodiment of the invention, or alternatively executable instructions for a method embodied on computer storage media according to an embodiment of the invention. In FIG. 12, a query is received 1210 comprising at least one keyword. A plurality of responsive results is displayed 1220 based on the received query. Supplemental query input is received 1230 comprising at least one of an image, a video, or an audio file. A ranking of the plurality of responsive results is modified 1240 based on the supplemental query input. One or more of the responsive results are displayed 1250 based on the modified ranking.

### Additional Embodiments

A first contemplated embodiment includes a method for performing a multi-modal search. The method includes receiving (1110) a query including at least two query modes; extracting (1120) relevance features corresponding to the at least two query modes from the query; selecting (1130) a plurality of responsive results based on the extracted relevance features; ranking (1140) the plurality of responsive results based on the extracted relevance features; and displaying (1150) one or more of the ranked responsive results.

A second embodiment includes the method of the first embodiment, wherein the query modes in the received query include two or more of a keyword, an image, a video, or an audio file.

A third embodiment includes any of the above embodiments, wherein the plurality of responsive documents are selected using an inverted index incorporating relevance features from the at least two query modes.

A fourth embodiment includes the third embodiment, wherein relevance features extracted from the image, video, or audio file are incorporated into the inverted index as descriptor keywords.

In a fifth embodiment, a method for performing a multi-modal search is provided. The method includes acquiring (1010) an image, a video, or an audio file that includes a plurality of relevance features that can be extracted; associating (1020) the image, video, or audio file with at least one keyword; submitting (1030) the image, video, or audio file and the associated keyword as a query to a search engine; receiving (1040) at least one responsive result that is responsive to both the plurality of relevance features and the associated keyword; and displaying (1050) the at least one responsive result.

A sixth embodiment includes any of the above embodiments, wherein the extracted relevance features correspond to a keyword and an image.

A seventh embodiment includes any of the above embodiments, further comprising: extracting metadata from an image, a video, or an audio file; identifying one or more keywords from the extracted metadata; and forming a second query including at least the extracted relevance features from the received query and the keywords identified from the extracted metadata.

An eighth embodiment includes the seventh embodiment, wherein ranking the plurality of responsive documents based on the extracted relevance features comprises ranking the plurality of responsive documents based on the second query.

A ninth embodiment includes the seventh or eighth embodiment, wherein the second query is displayed in association with the displayed responsive results.

A tenth embodiment includes any of the seventh through ninth embodiments, further comprising: automatically selecting a second plurality of responsive documents based on the second query; ranking the second plurality of responsive documents based on the second query; and displaying at least one document from the second plurality of responsive documents.

An eleventh embodiment includes any of the above embodiments, wherein an image or a video is acquired as an image or a video from a camera associated with an acquiring device.

A twelfth embodiment includes any of the above embodiments, wherein an image, a video, or an audio file is acquired by accessing a stored image, video, or audio file via a network.

A thirteenth embodiment includes any of the above embodiments, wherein the at least one responsive result comprises a text document, an image, a video, an audio file, an identity of a text document, an identity of an image, an identity of a video, an identity of an audio file, or a combination thereof.

A fourteenth embodiment includes any of the above embodiments, wherein the method further comprises displaying one or more query suggestions based on the submitted query and metadata corresponding to at least one responsive result.

In a fifteenth embodiment, a method for performing a multi-modal search is provided, including receiving (1210) a query comprising at least one keyword; displaying (1220) a plurality of responsive results based on the received query; receiving (1230) supplemental query input comprising at least one of an image, a video, or an audio file; modifying (1240) a ranking of the plurality of responsive results based on the supplemental query input; and displaying (1250) one or more of the responsive results based on the modified ranking.

Embodiments of the present invention have been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and subcombinations are of utility and may be employed without reference to other features and subcombinations. This is contemplated by and is within the scope of the claims.

What is claimed is:

1. One or more computer-storage media storing computer-useable instructions that, when executed by a computing device, perform a method for performing a multi-modal search, comprising:
acquiring an image, a video, or an audio file that includes a plurality of relevance features that can be extracted;
associating the image, video, or audio file with at least one keyword;
submitting the image, video, or audio file and the associated keyword as a query to a search engine;
receiving at least one responsive result that is responsive to both the plurality of relevance features and the associated keyword; and
displaying the at least one responsive result.

2. The computer-storage media of claim 1, wherein the image, video, or audio file further comprises metadata corresponding to the image, video, or audio file.

3. The computer-storage media of claim 2, wherein the at least one responsive result is responsive to the plurality of relevance features, the associated keyword, and one or more keywords extracted from the metadata corresponding to the image, video, or audio file.

4. The computer-storage media of claim 1, wherein acquiring the image or the video comprises acquiring an image from a camera associated with an acquiring device.

5. The computer-storage media of claim 1, wherein acquiring the image, video, or audio file comprises accessing a stored input via a network.

6. The computer-storage media of claim 1, wherein the at least one responsive result comprises a text document, an image, a video, an audio file, or a combination thereof.

7. The computer-storage media of claim 1, wherein the at least one responsive result comprises an identity of a text document, an identity of an image, an identity of a video, or an identity of an audio file.

8. The computer-storage media of claim 1, wherein the method further comprises displaying one or more query suggestions based on the submitted query and metadata corresponding to at least one responsive result.

9. A method for performing a multi-modal search, comprising:
receiving a query including at least two query modes;
extracting relevance features corresponding to the at least two query modes from the query;
selecting a plurality of responsive results based on the extracted relevance features;
ranking the plurality of responsive results based on the extracted relevance features; and
displaying one or more of the ranked responsive results.

10. The method of claim 9, wherein the query modes in the received query include two or more a keyword, an image, a video, or an audio file.

11. The method of claim 9, wherein the plurality of responsive documents are selected using an inverted index incorporating relevance features from the at least two query modes.

12. The method of claim 11, wherein relevance features extracted from the image, video, or audio file are incorporated into the inverted index as descriptor keywords.

13. The method of claim 9, wherein the extracted relevance features correspond to a keyword and an image.

14. The method of claim 9, further comprising:
extracting metadata from an image, a video, or an audio file;
identifying one or more keywords from the extracted metadata; and
forming a second query including at least the extracted relevance features from the received query and the keywords identified from the extracted metadata.

15. The method of claim 14, wherein ranking the plurality of responsive documents based on the extracted relevance features comprises ranking the plurality of responsive documents based on the second query.

16. The method of claim 14, wherein the second query is displayed in association with the displayed responsive results.

17. The method of claim 14, further comprising:
automatically selecting a second plurality of responsive documents based on the second query;
ranking the second plurality of responsive documents based on the second query; and
displaying at least one document from the second plurality of responsive documents.

18. A method for performing a multi-modal search, comprising:
receiving a query comprising at least one keyword;
displaying a plurality of responsive results based on the received query;
receiving supplemental query input comprising at least one of an image, a video, or an audio file;
modifying a ranking of the plurality of responsive results based on the supplemental query input; and
displaying one or more of the responsive results based on the modified ranking.

19. The method of claim 18, further comprising:
extracting additional keywords from metadata associated with the at least one image, video, or audio file;
incorporating the extracted additional keywords into the supplemental query.

20. The method of claim 18, further comprising:
extracting additional keywords from at least one responsive result based on metadata associated with the responsive result, the responsive result being an image, a video, or an audio file;
incorporating the extracted additional keywords into the supplemental query.
